(19) United States
(12) Patent Application Publication
(10) Pub. No.: US 2012/0111602 A1
(43) Pub. Date: May 10, 2012

(54) Signal transmission cable

(75) Inventor: Chih-Yin Wei, Taipei City (TW)

(73) Assignee: Quanta Computer Inc., Tao Yuan Shien (TW)

(21) Appl. No.: 13/064,435

(22) Filed: Mar. 24, 2011

(30) Foreign Application Priority Data
Nov. 5, 2010 (TW) 99138202

(51) Int. Cl. H01B 7/00

(52) U.S. Cl. 174/114 R

(57) ABSTRACT

A signal transmission cable including a conductive tape, a number of grounding conductive wires, a number of insulation wires in the first layer and a number of insulation wires in the second layer. The insulation wires in the first layer are used for transmitting a voltage signal, and the insulation wires in the second layer are used for transmitting a power set. The insulation wires in the first layer are paired and arranged on the conductive tape at an equal distance. The grounding conductive wires are embedded between the signal wire pairs for stabilizing the impedance. The insulation wires in the first layer and the insulation wires in the second layer are separated by a conductive tape for destructing the noise coupling effects between the layers. Lastly, the conductive tape covers the first layer and the second layer for impedance control and containing signal energy in the cable.

This application claims the benefit of Taiwan application Serial No. 99138202, filed Nov. 5, 2010, the subject matter of which is incorporated herein by reference.

### BACKGROUND OF THE INVENTION

1. Field of the Invention

The invention relates in general to a signal transmission cable, and more particularly to a signal transmission cable capable of reducing noise coupling and impedance variance.

2. Description of the Related Art

In the design of signal transmission cable, anti-electromagnetic interference (Anti-EMI) and the impedance matching are two important factors that must be considered. The EMI can be blocked by surrounding the insulation layer of the conductive wires with an aluminum foil or a metal fabric to contain the electromagnetic energy and signal inside in the cable and provide a grounding return path for high-frequency signal for reducing the interference caused by signal radiation. Currently, differential signal transmission is commonly used for reducing the common-mode noises between the transmission end and the reception end.

The conventional transmission cable normally has a circle or a flat structure. For the insulation wires wrapped in circle type, impedance still varies due to the power line and the signal line being twisted together and is thus difficult to control. For the insulation wires wrapped in flat type, the power line and the signal line will not be twisted together, but noise coupling still occurs between the power line and the signal line. Thus, the insulation wires wrapped in flat type still needs to be improved further.

### SUMMARY OF THE INVENTION

The invention is directed to a signal transmission cable adopting double layers stacking for decreasing noise coupling effects and impedance variance so that the transmission of signal is more stable and less likely to be radiated outside the cable.

According to an aspect of the present invention, a signal transmission cable including a conductive tape, a number of first insulation wires and a number of second insulation wires is provided. The conductive tape is rolled into an internal conductive layer and an external conductive layer. The first insulation wires are disposed in parallel and pressed flatly against the internal conductive layer for transmitting a grounding signal set and a voltage signal set. The second insulation wires are disposed in parallel and pressed flatly against the external conductive layer for providing a power set. The power set and the voltage signal set are separated by internal conductive layer. The first insulation wires and the second insulation wires are stacked in double layers and arranged inside the external conductive layer at an equal distance.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a signal transmission cable connected between the transmission end and the reception end according to an embodiment.

FIG. 2 shows a signal transmission wire along a cross-sectional line A-A according to an embodiment.

FIG. 3 shows impedance values and experiment data of a signal transmission cable according to an embodiment.

### DETAILED DESCRIPTION OF THE INVENTION

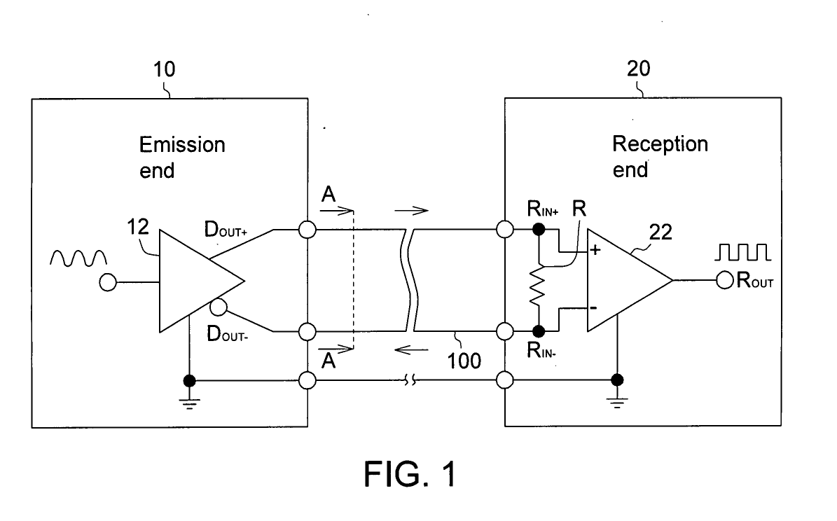

The present embodiment discloses a signal transmission cable for connecting a circuit having characteristic impedance. The characteristic impedance of the signal transmission cable matches the characteristic impedance of the circuit to avoid a portion of the signal being reflected to the transmission end and generating return loss or insertion loss. Referring to FIG. 1, a signal transmission cable connected between the transmission end and the reception end according to an embodiment of the invention is shown. The transmission end 10 has an operation amplifier 12, having two output ends DOUT+ and DOUT−, for generating a voltage signal set. The voltage signal set, in the manner of differential pair, is transmitted to the reception end 20 from the transmission end 10. In addition, the reception end 20 has an operation amplifier 22 for receiving the voltage signal set. In the present embodiment, the circuit coupled to the rear of the reception end 20 is such as an LCD driving circuit (not illustrated) for receiving a voltage signal with a work load so as to drive the pixel transistors inside the LCD.

In FIG. 1, the operation amplifier 22 of the reception end 20 has a first input end RIN+, a second input end RIN− and an output end ROUT. The first input end RIN+ is used for receiving a differential positive voltage signal. The second input end RIN− is used for receiving a differential negative voltage signal. The output end ROUT sends out a difference signal of the first input end RIN+ with respect to the second input end RIN−. In addition, there is an equivalent characteristic impedance R between the first input end RIN+ and the second input end RIN−, wherein the magnitude of the characteristic impedance R is such as 100 Ohm.

The above transmission can be used in a circuit for transmitting the signal by a low-voltage differential signaling (LVDS) cable to reduce the radiation of the common-mode noises between the transmission end 10 and the reception end 20, and keep the potential of the signal consistent from the transmission end 10 to the reception end 20 to avoid the transmission signal being interfered with by the noises.

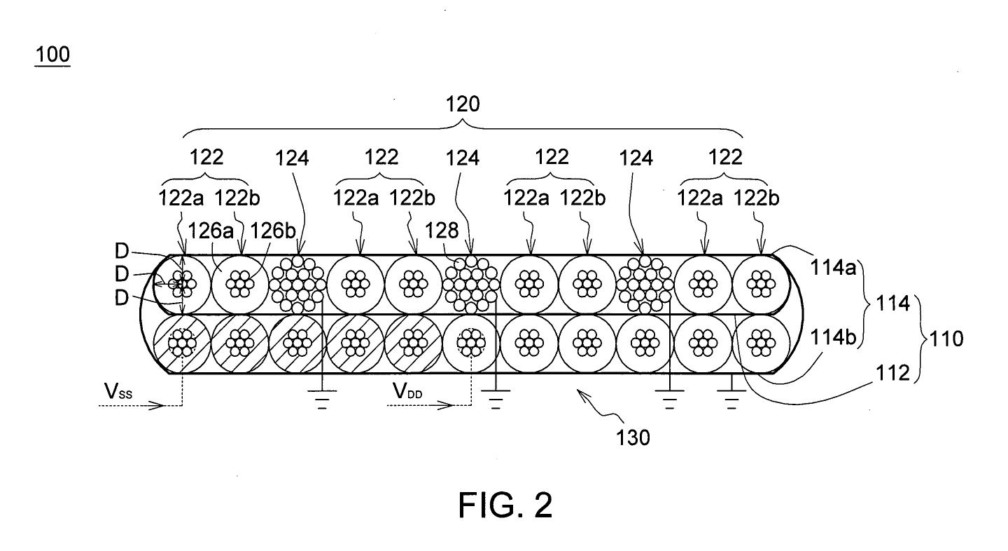

Referring to FIGS. 1 and 2. FIG. 2 shows a signal transmission wire along a cross-sectional line A-A according to an embodiment. The signal transmission cable 100 include a conductive tape 110, a number of first insulation wires 120 and a number of second insulation wires 130. The conductive tape 110 is rolled into an internal conductive layer 112 and an external conductive layer 114, wherein one side of the internal conductive layer 112 has a conductive adhesive through which the first insulation wires 120 can be pressed against the internal conductive layer 112. In addition, one side of the external conductive layer 114 has a conductive adhesive through which the second insulation wires 130 can be pressed against the external conductive layer 114.

In the present embodiment, the conductive tape 110 is such as conductive cloth containing conductive fibers or conductive cloth formed conductive material such as copper foil and aluminum foil. The conductive tape 110, being adhesive and flexible, can be wound to form several coils for covering the flat type first insulation wires 120 and the flat type second insulation wires 130 respectively. For example, when winding the first coil, the first insulation wires 120 are pressed flatly against a first portion (that is, the internal conductive layer 112) of the conductive tape 110 and then the first insulation wires 120 to be pasted on the first portion (the internal conductive layer 112) are turned over for pressing the first insulation wires 120 flatly against the second portion (that is, the upper layer 114a of the external conductive layer 114) of the conductive tape 110. Then, the second insulation wires 130 are pressed flatly against the third portion (that is, the lower layer 114b of the external conductive layer 114) that is not used. Then, the second insulation wires 130 to be pasted on the third portion or the first insulation wires 120 to be pasted on the second portion are turned over so that the first insulation wires 120 and the second insulation wires 130 are stacked and integrally formed as a double-layer structure. The first insulation wires 120 and the second insulation wires 130 are separated by an internal conductive layer 112 and covered in the external conductive layer 114 to complete the second coil of winding as indicated in FIG. 2.

According to the present embodiment, one coil of the internal conductive layer 112 and one coil of the external conductive layer 114 can be formed by one single conductive tape 110 for reducing the consumption of the conductive tape 110. In another embodiment, the internal conductive layer 112 and the external conductive layer 114 of the conductive tape 110 can be formed by two separate tapes. The invention is not limited to the above embodiments.

In addition, the first insulation wires 120 are pressed against the internal conductive layer 112 and disposed in parallel at a flat shape for providing a ground reference level and a voltage signal set. The voltage signal set is such as a set of differential pair signals. Besides, the second insulation wires 130 are pressed against the external conductive layer 114 and disposed in parallel at a flat shape for providing a power set. Since the first insulation wires 120 and the second insulation wires 130 are stacked in double layers, the horizontal size is thus reduced. Moreover, the voltage signal passing through the first insulation wires 120 and the power signal passing through the second insulation wires 130 are separated by the internal conductive layer 112, so power noise coupling is reduced and the signal transmission is more stable.

As indicated in FIG. 2, the signal transmission cable 100 has four channels and three grounding conductive wires 124. Each channel has a signal wire set 122, such as differential pair signal wires 122a and 122b, for transmitting differential pair signals and enabling each channel to execute transmission and reception functions at the same time. In addition, the signal wire set 122 of each channel are separated by a grounding conductive wires 124, so that the channel is surrounded by a conductive tape 110 for grounding and a grounding conductive wire 124. Consequently, noise coupling effects are reduced, the signal/noise ratio (SNR) of each channel is increased, signal quality is more stable and the impedance will not vary easily.

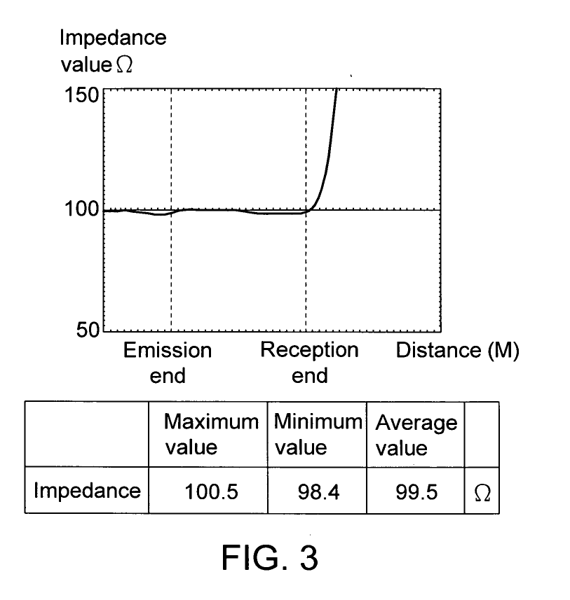

In the present embodiment of the invention, the signal wire set 122, such as multicored insulation wires, include an insulation layer 126a and a number of naked wires 126b covered by the insulation layer 126a. In addition, the grounding conductive wires 124 are formed by twisting the unicored naked wire 128 lacking the insulation layer. During impedance matching, the signal wires 122 (such as Teflon wires surrounded by an insulation slug in the color of red, black, blue or green) keep a consistent distance D with respect to the internal conductive layer 112 and the external conductive layer 114. Since the characteristic impedance of each signal wire set 122 is positively correlated with the distance D to the conductive tape 110, the impedance during signal transmission still can be within a certain range (as indicated in FIG. 3) and is thus easier for control. In an embodiment, the characteristic impedance of each signal wire set 122 matches the characteristic impedance R (such as 100 Ohm) of the reception end circuit for reducing return loss or insertion loss.

Referring to both FIGS. 1 and 3. FIG. 3 shows impedance values and experiment data of a signal transmission cable according to an embodiment. When the signal is transmitted to the reception end 20 from the transmission end 10, the maximum impedance of the signal transmission cable 100 is 100.5 Ohm, the minimum impedance is 98.4 Ohm, the average impedance is 99.5 Ohm (conventionally within +/−15 Ohm), and the impedance variance is small and is thus easy for control. Thus, the characteristic impedance of the signal transmission cable 100 of the present embodiment matches the characteristic impedance R (such as 100 Ohm) of the reception end circuit, so return loss or insertion loss can be effectively reduced.

Despite the signal transmission cable of the above embodiments is exemplified by a low-voltage differential signaling (LVDS) cable, the invention is not limited thereto. Any designs in which the signal transmission cable is formed by double-layer stacking and a conductive material is interposed between two layers for destructing the coupling effects and stabilizing the impedance are within the scope of protection of the invention.

To summarize, the signal transmission cable disclosed in the present embodiment of the invention adopts a double-layered stacking structure for reducing the noise coupling and impedance variance, so that signal transmission is more stable. The invention further has the following advantages:

(1) The horizontal size of the signal transmission cable is largely reduced to be about 3.85 mm far smaller than that of the conventional flat type signal transmission cable (about 12 mm). In addition, the vertical size of the signal transmission cable is about 1.3 mm being far smaller than that of the conventional circle type signal transmission cable (about 3.5 mm).

(2) The characteristic impedance has small variance, the power line and the signal line being disposed in different layers' will not be entangled together.

(3) Insertion loss and return loss are reduced, and both the rate and stability of signal transmission are increased.

(4) The conductive tape has the two layers (inner layer and outer layer) of shielding effect, so the signal wires are less affected by the voltage noise coupling and the electromagnetic interference (EMI).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A signal transmission cable, comprising:
a conductive tape rolled into an internal conductive layer and an external conductive layer;
a plurality of first insulation wires disposed in parallel and pressed flatly against the internal conductive layer for transmitting a grounding signal set and a voltage signal set; and
a plurality of the second insulation wires disposed in parallel and pressed flatly against the external conductive layer for transmitting a power set, wherein the power set and the voltage signal set are separated by the internal conductive layer;
wherein, the first insulation wires and the second insulation wires are stacked in double layers and arranged inside the external conductive layer at an equal distance.

2. The signal transmission cable according to claim 1, wherein the first insulation wires comprises at least a grounding conductive wire and a plurality of signal wire sets, and the grounding conductive wire is disposed between the signal wire sets.

3. The signal transmission cable according to claim 2, wherein the grounding conductive wire comprises a unicored wire.

4. The signal transmission cable according to claim 2, wherein each of the signal wire sets comprises a multicored insulation wire.

5. The signal transmission cable according to claim 2, wherein each of the signal wire sets comprises a set of differential pair signal wires.

6. The signal transmission cable according to claim 1, wherein the voltage signal set comprises a set of differential pair signals.

7. The signal transmission cable according to claim 1, wherein the power set comprises a positive voltage set and a negative voltage set.

8. The signal transmission cable according to claim 1 for connecting a circuit having a characteristic impedance matching the characteristic impedance of each of the first insulation wires.

9. The signal transmission cable according to claim 1, wherein each of the first insulation wires keeps a consistent distance with respect to the internal conductive layer and the external conductive layer.

10. The signal transmission cable according to claim 1, wherein the signal transmission cable comprises a low-voltage differential signaling (LVDS) cable.
